(19) United States
(12) Patent Application Publication
(10) Pub. No.: US 2026/0179479 A1
(43) Pub. Date: Jun. 25, 2026

(54) MONITORING SYSTEMS, DEVICES AND METHODS

(71) Applicant: RRU Services Limited, Pukekohe Auckland (NZ)

(72) Inventor: Joshua Parsons, Pukekohe Auckland (NZ)

(21) Appl. No.: 19/429,430

(22) Filed: Dec. 22, 2025

(30) Foreign Application Priority Data
Dec. 23, 2024 (AU) 2024904292

(51) Int. Cl. G08B 29/18; G08B 29/14

(52) U.S. Cl. CPC G08B 29/186; G08B 29/14

(57) ABSTRACT

A monitoring system includes at least one security sensor to receive at least one of sensor and event information about a site being monitored, a processor communicatively connected to the at least one security sensor, and a communications system to generate alerts.

### FIELD OF INVENTION

The present technology relates to monitoring systems, devices and methods. The present technology may find particular application in security monitoring systems, however this should not be seen as limiting and aspects of the technology may be used in applications such as access control, visitor management, and automated timekeeping.

### BACKGROUND TO THE INVENTION

Monitoring systems refer to any system which is used to monitor and track system assets, individuals, products and/or processes. The present specification focuses primarily on security monitoring applications which are designed to monitor access to premises, buildings, compounds, and sites. However other applications for the technology are discussed herein.

Existing monitoring systems typically employ a combination of access control measures, with monitoring or recording of access to enable review and auditing of access after access has occurred. Typical access control measures include biometrics, pins, passwords, and physical access measures such as keys and radio frequency access cards, sometime referred to as keyfobs. The access monitoring may include one or more cameras which may be actively monitored and/or recorded for review in the event of an issue arising.

Monitoring of cameras is an expensive process and can be prone to human error and fatigue. Most of the time that a camera is being monitored there will be nothing of interest to report. In some cases, there may be no notifiable events during the lifetime of a camera, and therefore there can be some apathy and fatigue from the individuals tasked with monitoring the system.

In addition, in order to be cost-effective, security providers will typically be monitoring a large number of cameras at any given time, therefore important events may be missed if the staff is focused on other matters at the relevant time. To help alleviate this, some systems employ automated motion detection to only alert the security provider when an event is detected. This helps to reduce the overall burden on the monitoring team. However, this can be prone to false positives, such as movement of animals, insects, vegetation, and access by authorised individuals.

Some technologies have been developed to help alleviate this issue, such as edge detection in the cameras which can allow for analysis of the video feed (or static images/frames thereof) to broadly identify that a person, vehicle or animal is present in the footage. Accordingly, filters may be applied such that the security monitoring team is only notified under certain conditions, such as when a person is present in an area. While this can be effective at reducing the total number of false positives, it still requires significant human resources to review and determine whether a notifiable event has occurred.

A further complication to these systems is that a security monitoring service will typically be monitoring a large number of different sites simultaneously, each site having different office hours, rules as to what is a notifiable event, and different escalation procedures. These rules can additionally vary from camera to camera, for example an internal camera may be subject to different rules in comparison to an external or outwardly facing camera.

Accordingly, when an event is detected, there is a burden on the reviewer to ensure that the correct procedure is followed for the specific site in question. Any errors made in any step of this process may result in a compromised or less effective monitoring system.

It is an object of the technology to provide monitoring systems, methods and/or devices configured to address any one or more of the foregoing issues.

Alternatively, it is an object of the present technology to provide a monitoring system which includes automated event detection and processing.

Alternatively, it is an object of the technology to at least provide the public with an alternative choice.

### SUMMARY OF THE INVENTION

According to one aspect of the technology there is provided monitoring systems, devices and methods.

According to another aspect of the technology there is provided monitoring systems, devices and methods which are configured to use AI technologies to extract additional information from one or more sensors.

According to another aspect of the technology there is provided monitoring systems, devices and methods which are configured to use AI technologies to interpret site rules.

According to another aspect of the technology there is provided monitoring systems, devices and methods which are configured to use AI technologies to determine whether alerts should be sent to users.

According to another aspect of the technology, there is provided a monitoring system, comprising:
at least one security sensor configured to receive sensor and/or event information about a site being monitored,
a processor communicatively connected to the at least one security sensor, and
a communications system configured to generate alerts,
   wherein the processor is configured to:
determine whether alerts should be generated based on a monitoring schedule for the site being monitored,
use an artificial intelligence model to:
   extract additional information from the sensor information,
   determine one or more rules for the site using natural language processing,
   review the sensor, event and context information to determine whether the one or more site rules have been met, and
   determine a level of risk from the sensor, event and context information, wherein, depending on the level of risk, the processor is configured generate an alert via the communications system.

In examples of the technology, the processor may be configured to use a large language model to extract additional information from the sensor information.

In examples of the technology, the processor may be configured to use a large language model to determine the one or more rules for the site.

In examples of the technology, the processor may be configured to use a large language model to review any one or more of the sensor, event and context information to determine whether the one or more site rules have been met.

In examples of the technology, the processor may be configured to determine the level of risk using a large language model.

In examples of the technology, the system may be configured to communicate the level of risk to a human reviewer for review, prior to generating an alert. For example, the alert may comprise an SMS message, MMS message, an email, push notification, phone call, or an audio/visual indicator.

According to another aspect of the technology, there is provided a method of monitoring a site, the method comprising the steps of:
a) receiving sensor and/or event information from at least one sensor or positioned to monitor a site:
b) processing the sensor and/or event information to determine whether it meets a monitoring schedule for the site;
c) using an artificial intelligence model to extract additional context information from the sensor and/or event information;
d) determining one or more site rules using natural language processing;
e) comparing the context information, sensor information and/or event information against the site rules to determine whether the site rules have been met or breached;
f) determine a level of risk from the sensor, event and context information; and
g) in the event that the risk exceeds a predetermined threshold, generating an alert via a communications system.

In examples of the technology, the use of artificial intelligence may comprise at least one large language model configured to extract additional information from the sensor information.

In examples of the technology, the step of determining one or more site rules may involve the use of at least one large language model.

In examples of the technology, the step of determining whether the site rules have been met or breached is performed using at least one large language model.

In examples of the technology, the step of determining the level of risk may be performed using a large language model.

In examples of the technology, the method may further comprise the step of communicating the level of risk to a human reviewer for review, prior to step g). For example the alert may comprise an SMS message, MMS message, an email, push notification, phone call, or an audio/visual indicator.

Accordingly, the present technology may provide one or more advantages over existing systems including:
Reduced human burden for security system monitoring systems;
Reduced false-positive alert generation;
Allowing easy configuration using natural text rules;
The ability to automatically extract more detailed information from sensors; and
Rapid improvement to site monitoring due to a feedback loop generated between the Large Language Model (LLM) and the monitoring agent. This feedback loop includes at least two types of feedback:
   Feedback to the agent from the LLM on what is present in any given snapshot and how that aligns with site specific rules and SOP's (Standard Operating Procedure).
   Feedback from agent to LLM on whether its assessment of the scenario was accurate and thorough.

Further aspects of the technology, which should be considered in all its novel aspects, will become apparent to those skilled in the art upon reading of the following description which provides at least one example of a practical application of the technology.

### BRIEF DESCRIPTION OF THE DRAWINGS

One or more embodiments of the technology will be described below by way of example only, and without intending to be limiting, with reference to the following drawings, in which:

FIG. 1A shows a simplified block diagram of a security system.

FIG. 1B shows a block diagram of a security system configured to extract event information from one or more security sensors.

FIG. 1C shows a schematic view of a monitoring system according to the present technology.

FIG. 2A shows a block diagram of an exemplary workflow for processing sensor and event information and generating alerts.

FIG. 2B shows a block diagram of an example of initial processing of event and sensor information referred to herein as level 1 processing.

FIG. 2C shows a block diagram of an example of AI processing techniques referred to herein as level 2 processing.

FIG. 2D shows a block diagram of a method of processing information using large language models referred to herein as level 3 processing.

FIG. 2E shows a block diagram of a method of determining threat referred to herein as level 4 processing.

FIG. 2F shows a block diagram of a notification system referred to herein as level 5 processing.

### BRIEF DESCRIPTION OF PREFERRED EMBODIMENTS OF THE INVENTION

### Overview of Monitoring Systems

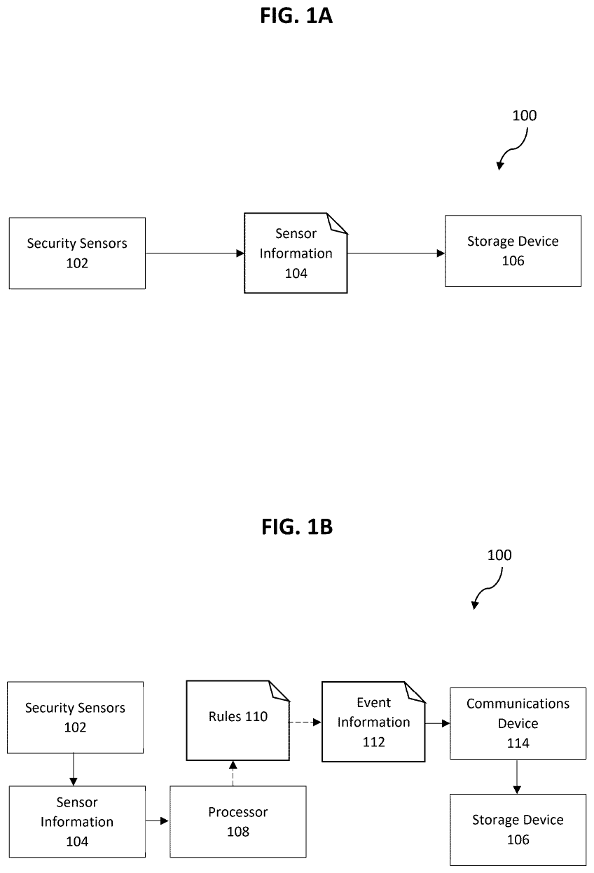

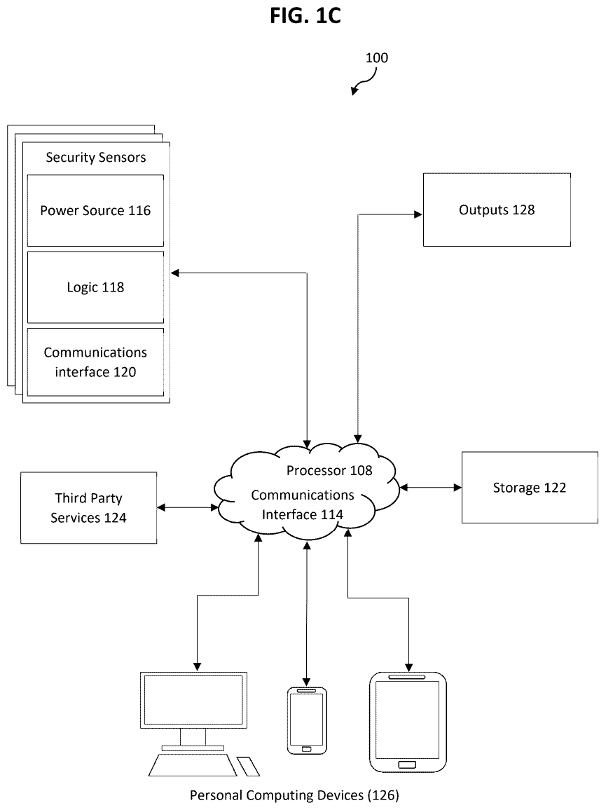

Aspects of the present technology relate to monitoring systems 100, which may be referred to herein as security systems. These systems 100 typically include one or more security sensors 102 such as motion detectors, cameras, glass break sensors, and smoke detectors which are configured to capture sensor information 104. The sensor information 104 may in some cases trigger an alert (such as a smoke alarm activating an audible alert on detecting smoke). In other examples such as is illustrated in FIG. 1A the sensor information 104 may be sent or stored for later review for example the sensor information 104 may be sent to a storage device 106 such as a local, remote or cloud-based storage means or server.

In the case of monitored security systems 100, the sensor information 104 may be reviewed and if necessary and an action performed for example the action may be to contact the police, dispatch someone to investigate the event, or to call a nominated contact etc.

Some examples of the present technology relate to local monitoring systems, where the system is monitored on site, while in other examples the technology may be used by security monitoring businesses, who are tasked with monitoring, reviewing and triggering alerts as required.

### Security Sensors

Reference herein is made to security sensors 102 generally, with certain examples of the technology using information captured from sensors in the form of one or more cameras. Reference to security sensors 102 however should not be seen as limiting, and in some examples the monitoring systems described herein may use either a single sensor, a combination of different sensors, or a plurality of sensors of any type.

For example, a monitoring system for a retail store may include one or more glass break sensors, to detect a window or display cabinet being broken, one or more motion detectors configured to detect movement within the store, one or more cameras to help identify individuals within or outside of the store.

With reference to FIG. 1B each of the security sensors 102 may be configured with a set of rules which define what sensor information 104 should be sent or stored. In some examples these rules may be configured on the sensors 102 themselves, for example the sensor 102 may include a processor 108 that allows for adjustable motion detection areas, or sensitivities such that sensor information which does not meet the pre-configured requirements is automatically discarded.

Reference herein to ‘a processor’ or ‘processors’ 108 should be understood to include the singular meaning of this term, together with a plurality of processors which are configured to communicate with each other. For example, in any processing task described herein, a processor may offload one or more processing tasks to another processor, including in some examples cloud-based processors.

Accordingly, the sensors 102 may be configured to communicate with one or more processors 108 which are external to the sensor 102. For example, the monitoring system may include a dedicated security controller, computer, or server which includes at least one processor configured to compare the sensor information 104 against a predefined list of one or more rules 110 to determine whether sensor information 104 should be escalated (such as being recorded for later review, sent to a person to review, or for an alarm to be triggered). In some examples the processing performed on the sensor may be referred to as logic 118, while the processor configured to review the sensor/event information may be referred to as the processor 108. This should not be seen as limiting however, and as noted the system may comprise a single sensor or multiple sensors.

For example, a glass break sensor may be configured such that irrespective of the time of day, the sensor information 104 (which in this case would be the detection of glass breaking) would be communicated for storage, review or action. However conversely, sensors 102 in the form of cameras may be configured to have different rules based on the region of the camera field of view where motion is detected, and/or time of day etc.

In another example, a camera may be configured to record all footage obtained during business hours for storage in the event that a crime is detected. In this case, the sensor information 104 may just simply involve camera footage, whether this is a continuous stream of video/images or whether this footage is motion activated as is common for security cameras. However outside of business hours, it may be advantageous any motion capture detected within the store to be both stored and escalated for review, in case for example the motion capture is indicative of a break-in after hours.

Accordingly, in some examples of the technology, the sensors 102 may include or otherwise be configured to communicate with one or more processors 108, to check the sensor information 104 against one or more pre-defined rules 110 for the business. Should the pre-defined rules be met, the processor 108 may be configured to send event information 112 to a storage device 106, for example using a communications device 114, such as a wireless or wired network.

### Rules

Throughout the present specification reference to rules 110 may be in regard to any user-configurable rule for a site being monitored. Typical examples of rules 110 include active business hours, authorised personnel, the type of event being detected, and what actions should be taken in response to certain rules being met.

Some aspects of the present technology, use artificial intelligence technologies to expand on the types and specificity of rules 110 which are available to security monitoring systems. These AI augmented rule systems are described in greater detail herein.

### Object Detection

Recent technology developments have allowed for sensors 104 such as cameras to be provided which include object recognition. For example, the camera may include a processor 108 which is able to both detect the location of an object in an image (or series of images such as video), and classify using a trained classification model, what the object is (such as a person or an animal for example). This technology may be known as edge-based video surveillance to those skilled in the art.

These technologies typically employ machine vision technologies such as edge detection, semantic segmentation and image classification to determine what the object within an image is. Accordingly, these technologies take the sensor information 104, in the form of image frames, and generate event information 112, such as a notification that a person is detected. While these edge detection technologies are not perfect, they can significantly reduce the review burden, as classifications of objects (such as trees), and animals (such as birds and cats) can automatically be ignored without requiring human review. This reduces the number of false positives notifications, reducing monitoring burden and costs.

### Event Information

Reference to event information 112 should be understood as being separate to (but may also include) sensor information 104. In other words, event information 112 is intended to refer to sensor information 104 which has been processed to extract additional information. Accordingly, this information may include meta-data in addition to, or in place of the raw sensor data. For example, when object detection technologies are employed as described herein, the event information 112 may comprise both sensor information 104 in the form of one or more frames of video/audio in addition to event information such as information that a person was detected, at a certain time of day (for example after hours).

In other examples the event information 112 may comprise sensor data 104 with time-of-day data, or combine two or more sensors, such as a motion activation alert together with video/image/sound information in the area where the motion activation was triggered.

This event information 112 may advantageously reduce storage burden for the sensor information, allowing for reduced network transfer bandwidth, data storage costs, and increasing the duration that captured information to be stored for. In addition, where the monitoring system 100 is an actively monitored system, it may advantageously reduce the human review burden of false positives, which may reduce the costs, and increase the accuracy of the monitoring.

### Actions

Reference herein is made to actions and alerts that may be performed in response to detecting notifiable events, such as movement on a movement sensor, or a person in a camera feed when a schedule indicates that no person should be present. These actions and alerts may include:
Notifying individuals of a person or event on site, for example via email, SMS message, push notification or call.
Requesting confirmation of whether a person or event is expected to be present or occurring on site.
Notifying security, such as safety officers and/or police.
Triggering audible alerts, sirens, spoken warning messages, alarms, whether a silent alarm, or an audible/visual alarm.
Activating security locks, walls, or doors.
Activating smoke cannons.

### Hardware

With reference to FIG. 1C, the present technology may be implemented using any suitable hardware. For example, one or more sensors 104 may be provided. Each of the sensors 104 may have their own power source 116 (such as battery or solar power) or otherwise be configured to connect to an AC or DC power supply.

Some sensors 104 may include logic circuity 118 configured to process the data collected via the sensor 104. For example, in a camera, this may involve the conversion of images captured on a charge coupled device (CCD) or complementary metal-oxide-semiconductor (CMOS) to individual images, or a video stream (such as via a real-time streaming protocol). In some examples, the logic circuitry 118 may include a processor such as a microprocessor or controller.

In some examples the logic circuitry 118 may further allow for configuration of the sensor, such as adjusting sensitivities, focal lengths, active regions etc.

The security sensors 104 also include a communications interface 120 for facilitating transmission of the sensor and/or event information to/from other sensors within the system, and or a processor 108. The communications interface 120 may comprise a wired or wireless connection. For example, it may include analogue or digital signal transfer over one or more conductors, or wireless transmission, for example using a WiFi or Bluetooth network.

In the illustrated example, the processor 108, is shown as being a cloud-based processor 108, i.e. a server which is hosted remotely to the security sensors 104. Although this should not be seen as limiting and in examples described herein, the processor may be local to the site being monitored. A communications interface 114 is provided for communicating with the processor 108, for example, using wired or wireless interfaces.

In some examples of the technology the monitoring system comprises storage 122, configured to receive and store information either from the sensors 104, or from the processor 108, including:
Recordings from one or more cameras;
Sensor and/or event information;
Schedule information;
Processor decision information; and
One or more AI models.

The storage 122 may be used as required, irrespective of whether the monitoring system is configured for active monitoring.

In some examples of the technology, the system may be configured to communicate with one or more third party services, such as AI service providers, human resource management software, staff calendars, schedules etc.

One aspect of the present technology is the ability to send alerts to notify users of events occurring within the monitoring system 100, accordingly the processor 108 may be configured to send alerts to one or more personal computing devices 126 via the communications interface 114. These notifications may include SMS, MMS, email and push notifications. In some examples, the personal computing device(s) 126 may allow for configuration of the monitoring system 100, such as reviewing the sensor/event information in real-time, requesting sensor information from storage 122, and reviewing decisions made by the processor 108.

In some examples of the technology the processor 108 may further be configured to provide one or more outputs 128, such as activating visual/audible alarms, controlling access control systems, lighting, smoke machines etc.

### Security Monitoring Architecture

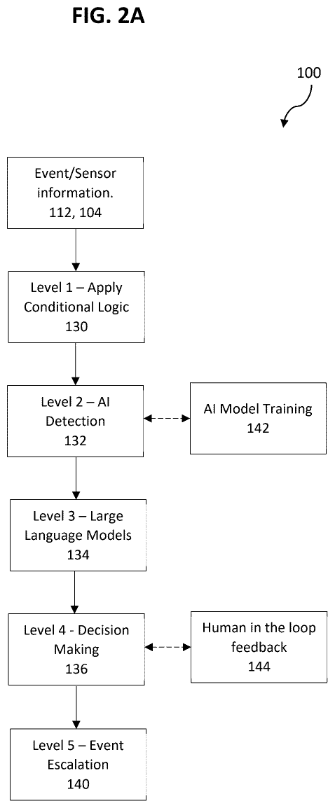

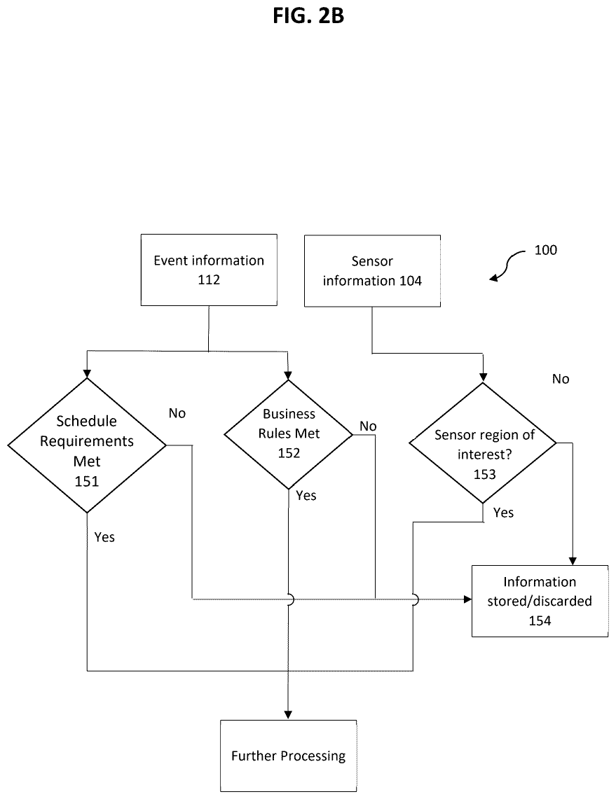

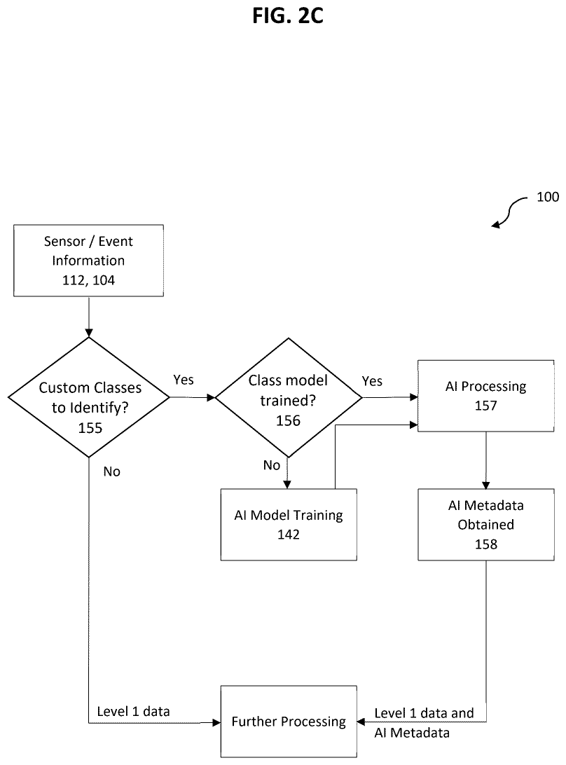

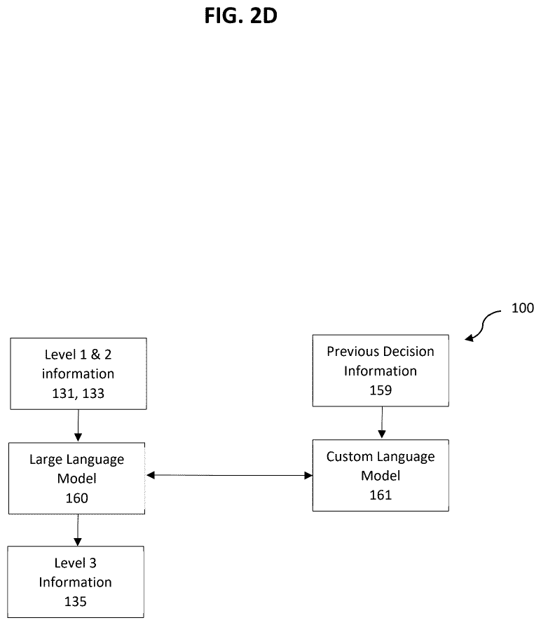

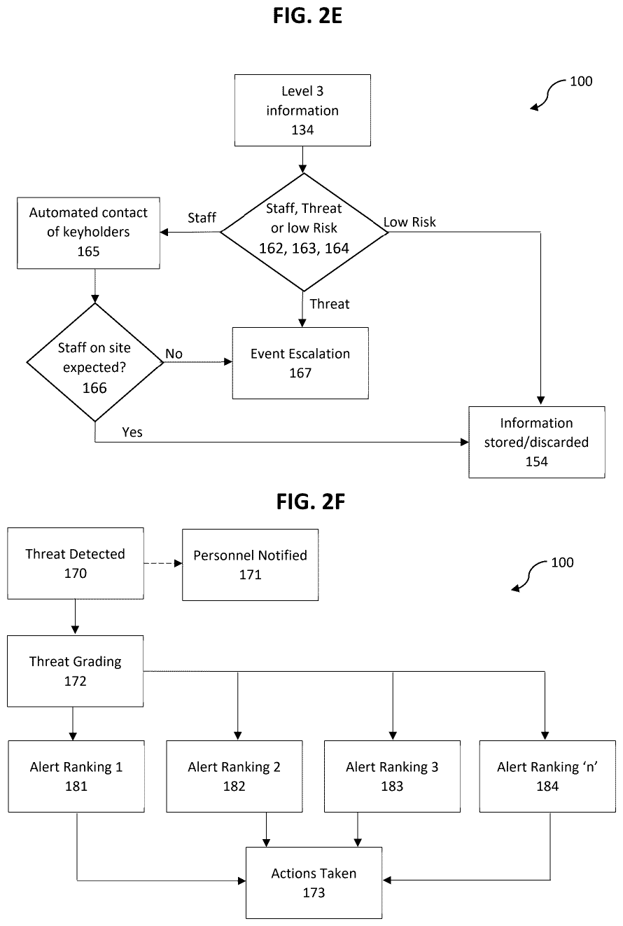

Example monitoring systems and methods are shown and described in relation to FIGS. 2A to 2F. In these examples a system, and methods are provided which at a high level receive and process sensor 104 and event information 112 from one or more sensors 104 in order to determine whether any action should be taken, and if so, what the action should be. The present systems and methods are described with a sequence of steps which may be performed sequentially, or in parallel with one another, however this should not be seen as limiting on the technology, and the logic described may be performed in any suitable order. FIG. 2A depicts an exemplary workflow for processing sensor and event information and generating alerts. Initially, event/sensor information 112, 104 is received by the monitoring system 100. After that, the following stages of processing occur: Level 1—Apply Conditional Logic 130 Level 2—AI Detection 132 along with AI Model Training 142 occurs, Level 3—Large Language Models 134, Level 4—Decision Making 136 along with Human in the loop feedback 144, and then Level 5—Event Escalation 140.

### Conditional Logic Processing

In some examples of the technology, the sensor 104 and/or event information 112 provided by the one or more sensors 104 may be passed to a processor 108 configured to apply conditional logic to analyse the information. This may be referred to herein as level 1 processing (i.e. Level 1—Apply Conditional Logic 130), and examples of this are described with reference to FIG. 2B.

For example, the processor 108 may be configured to review the sensor and/or event information 112 and compare the information against a schedule or calendar, in order to determine what further action should be taken. For example, the processor 108 may determine that the event information 112 occurred during site active hours, and therefore that no further action may be required, or that the event information should be stored in the storage 122 for record keeping purposes. In other examples the schedule may indicate that the information comes from a sensor 104 which is scheduled to be active, or more generally during an active time for the site being monitored, in which case the sensor/event information may be processed further.

In some examples, a site being monitored may have active hours which disable or otherwise prevent notifications from a number of the sensors, while still maintaining alerts on some important sensors (such as access to restricted areas for example).

The schedule information may also include information such as staff hours, expected rubbish collection times, cleaner schedules, etc. This schedule information can therefore be automatically categorised and actioned accordingly, if the information is generated at times when the schedule shows that people are expected to be present.

Accordingly, the processor 108 may compare the sensor and event information against one or more scheduling rules, these can include active hours (such as 5 PM-9 AM) active days such as weekends, or specific days of the week. In some examples the processor may have access to one or more calendars, or staff rosters, in order to automatically whether an individual should be on-site, and whether an event should be further processed or escalated.

In some examples, the processor 108 may analyse the event information 112 to determine whether it meets and one or more pre-defined rules. For example, where the event information 112 is provided by a sensor with edge-based video surveillance as described herein the event information 112 may indicate the nature of any events or objects detected, such as whether the image of video includes an image of a person, animal, insect etc. Based on the site rules, this event information 112 may be used to determine whether the event information should be escalated further. For example, detecting a cat outside a residential address may be sufficiently low risk that the event is discarded, while detecting a person within a secure facility may require further review/processing.

This technology is not limited to edge-based video surveillance, for example, event information may be received from a plurality of sources, such a sound sensor detecting voice, specific frequencies of sound indicative of cutting or grinding, or sounds which are louder than a predetermined threshold, or have a duration which exceeds a predetermined threshold.

In some examples, the processor 108 may further be configured to analyse both event information 112 and sensor information 104 in order to determine whether the event should be processed further.

For example, the processor 108 may receive event information 112 such as the detection of motion in a secure area. This event information 112 may be analysed in combination with sensor information such as one or more images or video frames to determine whether the motion occurred in an area of interest. If the event occurred in an area of interest, the information may be processed further, and if not, the information may be discarded or stored in storage 122 for future reference.

Accordingly, level 1 processing is configured to receive event information 112, and/or sensor information 104, and process the information to determine whether pre-configured schedule requirements have been met 151, one or more business rules are met 152, and/or that the sensor information includes activity in a region of interest 153. If these requirements are met, the sensor and/or event information may be further processed. If these requirements are not met, the sensor and/or event information may be logged and/or discarded 154.

Reference herein to discarding information should be understood to mean that the information is not processed further, i.e., that the information did not warrant further review. This information may be logged or stored for further review.

Level 1 processing may utilise a Unified Object Analytic Model (UOAM) which analyses image and/or video from the cameras and identifies any objects within the image.

For example, the UOAM may determine that there is a security guard in the footage from a camera. This information from the UOAM can be used by the system in identifying threats along with other data such as site specific instructions denying access to the public. Since a security guard is not part of the public, they would not be a threat. However, it may determine that a person dressed in casual clothing entering the site may be determined a threat as they may be identified as part of the public. Other examples may include the detection of objects including at least as weapons, animals, vehicles, etc. Image/video object recognition services such as Amazon's Rekognition service may be used to identify object with camera images and footage.

### AI Detection

With reference to FIG. 2C, one aspect of the present technology is to provide advanced AI image processing techniques to extract additional meta-data from the event information 112 and sensor information 104 described herein (i.e. Level 2—AI Detection 132).

For example, for a given site being monitored, it may be advantageous to have an AI model which is able to detect context or meta-data from sensor data. For example, in the case of image and/or video information it is possible to provide an AI model with image/video data and have the AI model assess that data to extract additional information.

For example, while conventional object detection algorithms can detect and classifying objects within an image, it is possible to train a model to extract additional context from images. This additional context is extracted by training one or more custom classes to detect specific features and behaviours through AI Model Training 142. For example, while a conventional object detection algorithm may identify a person in an image, a custom class may be trained 156 to determine whether the person is likely to be a homeless person, for example by detecting the presence and proximity of sleeping blankets within the image/video fees.

In another example where it is desirable to detect catalytic theft from cars, an AI model may be configured to detect whether a both a car and a person is present in the image/video feed and furthermore whether the person is close to an undercarriage or wheel of the car. Other characteristics may be considered to be relevant to theft detection such as whether the vehicle has its headlights on for example.

Other examples may include automatically detecting whether a person is likely to be hostile by detecting weapons in the images, or whether the person is concealing their identity, such as by using face coverings.

These models may be trained using any methods known to those skilled in the art, including but not limited to supervised learning, whereby labelled image/video samples are used to determine key characteristic feature vectors from the relevant images/video and recursive learning, i.e., where the output of the model is provided as an input to learn from past decisions/outputs.

Accordingly, depending on the usage requirements the present technology may use a custom class model 156 to extract additional information from sensors such as the cameras providing images and/or video information using AI Processing 157. If this additional context is not required, the level 1 data may simply be passed to the level 3 processing system 134. Otherwise, a trained AI model may add additional metadata which can be provided with the level 1 data.

In the event that custom classes are required 155, but are not present (i.e., have not yet been trained) a model may be trained as required, using any techniques familiar to those skilled in the art.

Accordingly, the output of the level 2 processing may include any one or more of the event information 112, the sensor information 104, information about the schedule requirements 151, business rules 152, and regions of interest 153, together with any additional meta-data 158 extracted from the AI model.

### Large Language Model Processing

One aspect of the present technology is to include a large language model (LLM) 160 to automatically extract additional information from the systems described herein (i.e. Level 3—Large Language Models 134). LLMs should be familiar to those skilled in the art, but for sake of completeness an LLM is type of natural language processing (NLP) system which is trained to comprehend and generate human language text. Some LLM models are also able to receive and process images and can process and describe what is shown in images. Examples of publicly available LLM models include ChatGPT by OpenAI, and Llama by Meta.

The present technology utilises LLM text processing for both allowing for specific site rules to be analysed, and to enable processing of visual information in the form of images, and/or video frames.

Accordingly, with reference to FIG. 2D, an LLM 160 may be provided with any of the information previously discussed in respect of the level 1 and level 2 processing (131, 133). This can include:
One or more images from a security camera.
Information from previous images (i.e., discrete images or a video feed).
Sensor information.
Event Information.
Specific information relating to the sensor the information comes from.
Schedule information.
Business rules, including rules for the site.
Sensor regions of interest.
AI metadata obtained from a custom class model.

This information can then be provided to the LLM 160, and the LLM 160 may be tasked with generating additional contextual information. For example, the above information may be collated and provided to an LLM 160 with a series of one or more prompts which are configured to obtain contextual information in a specific format (such as being tabulated, or otherwise formatted for easy processing).

For example, contextual information may be obtained with a prompt of the following format: “The following is an image of a security camera monitoring a carpark. The region of interest is the asphalt area within the fenced perimeter. Any activity which occurs outside of the fenced perimeter can be ignored. The current time is 9:05 PM. There should be no one within the carpark area between 7 PM and 6 AM. Security officers will patrol the carpark every 30 minutes driving golf carts and wearing high-visibility vests. With this context information, the LLM 160 may be prompted to provide additional contextual information. For example, a series of prompts may include:
“Describe what is shown in detail”.
“Is anyone present who should not be?”.
“Is there any suspicious activity occurring?”.
“The following is the analysis from the previous image, what differences are there if any between these images?”.
“Are the differences (if any) likely to due to unauthorised access to the carpark?”.

As such, the LLM 160 may be used to extract additional information from the sensor information 104 and event information 112, in order to provide more precise automated detection of potential issues on a site.

In contrast, conventional security monitoring systems typically only allow configuration of a few pre-set options. For example, it may be possible to configure active hours, motion detection regions, preset motion detection sensitivities, and in the case of edge-based video surveillance coarse object detection such as alarming when a person is detected. The present technology in contrast may be easier to configure, as rules can be entered in plain text, the alarming may result in reduced false positives, by focusing specifically on information of interest, and as a result, the cost of security monitoring may be significantly lower for the end user.

The above examples should not be seen as limiting and the information, prompts and rules can be a specific as needed. For example, a rule may be set for detecting specific vehicles or people on site, such as a blue Honda Civic being indicative of the site manager being present. In other examples, the rules may be more abstract, such as detecting potential hostile situations. For example, an LLM 160 may be used to process an image or series of images to determine the likelihood that a person is being attacked or is about to be attacked.

In some examples, an LLM 160 may be able to communicate that it is difficult to discern features within an image. For example, a frame of a video feed may include a bird quickly flying past the camera. In these situations, the LLM 160 may provide the processor 108 with information that the image is unclear, and a subsequent image may be provided in an attempt to provide greater detail and address the issue identified.

Training of LLM models can be computationally and resource intensive, as such it can be advantageous to leverage publicly available LLM models for the core tasks of processing rules and determining context from an image. However, in some examples of the technology, it may be beneficial to use a Custom Language Model (CLM) 161 which is trained at least on previous decisions 159 and alerts generated in response to events. For example, the CLM 161 may be used to adjust behaviours and context provided by commercially available large language models. In addition, these custom models may be trained on specific features of an environment in order to provide additional information to the model. For example, in a business that sells firearms it may be advantageous to train the AI model to only detect threats when a firearm is aimed at another person, as opposed to simply seeing firearms themselves as threats.

Through the process of utilising software to detect criminal activity, the resulting data can be used to create a data set for the CLM 161. The CLM 161 will continue to adapt and gain confidence as it gathers more site-specific data. Since all decision making done by the system is based on assigned confidence ratings, additional data will increase the confidence of the model in any given circumstance. An example of the LLM 160 and CLM 161 working in a unified fashion is wherein a goal of security for a site is to prevent the theft of clothing through joint camera/human monitoring. The LLM 160 would be able to identify suspicious behaviour or actions that would appear to be shoplifting. The CLM 161 could provide context of store-specific patterns, such as vulnerable areas of the store, most often stolen items, or specific weaknesses or blind spots in store surveillance. The combination of these two models together allows the system to provide analysis with a higher level of confidence. Further, it would also result in an analysis of increasing confidence as the CLM domain specific data expands.

### Decision Making

With reference to FIG. 2E, one example of a decision-making process (i.e. Level 4—Decision Making 136) is shown. In this example the contextual information (i.e. Level 3 Information 135) provided by the LLM 160 is processed to determine whether the event information 112 is indicative of staff present on site 162, a threat being detected 163, or a non-event, i.e., a low risk of a notifiable event 164. Note that these categories are described by way of example only and should not be seen as limiting. For example, the decision-making process may be used to distinguish over any types of events, including but not limited to detecting homelessness, threats in public spaces, movement in restricted areas, etc.

In the illustrated example, a processor is configured to receive the information from the LLM and is tasked with determining whether the context information is indicative of staff present on site 162, a threat situation 163, or a low risk event 164, such as nothing of interest to report. Part of the decision-making process may be achieved by prompting the LLM for specific questions, including in a specific format to allow simplified processing of the responses. For example, a series of prompts may include: “Provide a score between 0 and 100 for the likelihood that a staff member has been detected on site, where a score of 100 is highly likely and a score of 0 is not likely”. This score can then be compared against a predetermined threshold which determines which action should be taken.

In the event that the likelihood is high, such as greater than 70, actions, such as the automated contact of keyholders can be performed automatically 165. In the event that a medium likelihood of a staff is detected, such as between 30 and 70, the footage and event information may be passed to a human for review, and in the event that a low likelihood (such as less than 30) is detected, the information may simply be stored or discarded 154 without further actions taking place. In each example these predetermined thresholds may be adjusted based on the rules of the site (i.e., in high-security applications it may be beneficial to escalate any event, even with low confidence, or vice-versa in low-security applications).

Accordingly, prompts may be prepared to detect any number of events of interest, including generic prompt templates which are able to accommodate any rules a site owner may configure. For example, a prompt may be: “Provide a score between 0 and 100 for the likelihood that [user entered condition to detect] is present, where a score of 100 is highly likely and a score of 0 is not likely”. Similar prompts may be used for each condition which is allowed on site, with the logic being reversed as necessary, for example a prompt may be: “Provide a score between 0 and 100 for the likelihood that [user entered allowable condition] is present, where a score of 100 is highly likely and a score of 0 is not likely”. This information may be used accordingly to direct the flow through a monitoring method.

Referring back to the example of FIG. 2E, when the monitoring system detects that staff may be present on site, action may be taken accordingly. In this example, the action involves the automated contact of keyholders 165. For example, a notification may be sent to a pre-configured list of contact people, referred to herein as keyholders, but may refer to any designated contact people. This notification may include text, image, video and or audio as required. For example, the notification may include a prompt such as “Are staff expected to be on site?” 166, potentially with an image showing the detected person. In the event that a “Yes”, “Y”, or any other positive indication is returned (positive indications may be determined using large language models as described herein), then notifications may be temporarily disabled for a period of time (such as 30 minutes), and the event and response stored/logged for future reference. In the event that a negative response is detected the event may be escalated 167. In the event that an ambiguous response, or no response is received within a predetermined time period, then further action may be taken including but not limited to escalation to a security team, automatically calling keyholders, notifying police, or taking any other action which may be appropriate in the given application.

### Event Escalation

With reference to FIG. 2F, in the event that a threat is detected 170 (a threat may be any notifiable event defined by the user, or a threat automatically identified by the systems described herein), the monitoring system 100 may automatically go through an escalation process 167. As an initial step, the monitoring system 100 may be configured to notify key staff that a threat has been detected 171. This may be using any suitable method including SMS, push notifications, calls, emails etc. In other examples, the threat may first be graded 172 prior to any actions being taken (including notifying relevant personnel).

The threat may then be assessed and a grade or ranking assigned based on any number of factors, including predetermined factors such as which sensor triggered the event, site schedules etc, as well as risk factors identified by the AI systems described herein. For example, this can include whether weapons are detected, the number of people detected, whether or not there are concealed identified, whether certain behaviour is detected, such as fighting, sleeping, or walking a dog.

Each of the risk factors may be applied a value indicative of its weighting, either positive or negative to reflect low-risk and high-risk events accordingly. For example, a street facing camera outside a business, may rank a person walking a dog as low risk which may have a value of close to neutral (such as between +0.5 and −0.5, or substantially zero), while detecting a person wielding a knife may carry a higher risk value such as between +5 and +10 for example depending on their hostility and proximity to the business being protected. By assigning values to the risk, it may be possible to rank the risk based on severity and take action accordingly. These values may be configured to be dependent on the site attributes, and sensor location for example detecting a person in a high-security location may warrant a high value, while detecting a person on the street outside a business may warrant a relatively low value. Similarly, the alert thresholds may be adjusted depending on site attributes, for example in a secure government facility, thresholds may be set to trigger actions at low value totals (such as a sum of all threat values), while a public facing site may require a total value of 5 (which can come from one or multiple different potential threats) or more before triggering a notification.

In some examples of the technology, the notification system may include a plurality of alert rankings, whereby the actions taken 173 can be customised for each alert ranking. For example, a first alert ranking 181 may be triggered when the total scalar value exceeds a first threshold such as ‘3’. In this event a first set of contacts may be notified. A second alert ranking 182 may be triggered, when the total scalar value exceeds a send threshold such as ‘5’. In this event, a second set of contacts may be notified, and a request for confirmation sought. For example, using a SMS, phone call, push notification or email, the designated contacts may be asked to review and confirm whether the event is acceptable before taking action. In the event that a response is not received within an allocated time window, the alert may be escalated, for example by triggering an alarm and/or notifying the police.

In some examples a third alert ranking 183 may be triggered when the total scalar exceeds a third threshold such as ‘7’. In this example, an alarm may be triggered immediately and police automatically notified.

The systems described herein may be implemented with any number of configurable alert thresholds and rankings as required as exemplified by alert ranking ‘n’ 184.

### Human-in-the-Loop Feedback

Human-in-the-loop (HITL) feedback and training systems should be familiar to those skilled in the art, and in general terms these systems use input from human reviewers to train, and fine tune decisions made by an AI. This can advantageously, increase the accuracy of the AI models over time, and align their decision making more closely to that of the human providing feedback.

Accordingly, one aspect of the present technology is to provide a security monitoring system which is:
Configured to receive event information from one or more sensors, including at least one camera;
Use an AI model to perform context detection on the images provided by the at least one camera;
Determine potential risk based on rules configured by a user;
Pass information relating to the event information and potential risk to a human for review/feedback;
Update the AI model with the feedback from the user; and
If necessary, generate an alert based on the potential risk.

As a result, the present system may provide a human augmented monitoring system in which the AI generated threat values are passed to a human to review before any further action is taken. In some examples the information passed to the human may comprise the sensor information, the event information and the threat risk value. In other examples the LLM described herein may provide additional human readable context as to why the risk score was selected, for example a detailed description of why they though an object or person within an image was deemed to have the risk factor it did. An example of the human readable context may be: “A person was detected on street camera 2, however it appears that this person is simply walking a dog, and was therefore categorised as low risk, please confirm”.

It should be appreciated that this feedback loop may be performed both where the AI model determines that there is a threat, and in situations where the AI model determines that there is no threat.

Over time, as the AI model becomes better at accurately categorising threats in the same manner as the human reviewer, the human may be removed from the loop such that the system automatically detects and triggers events according to the sites risk profile and rules.

The AI models may further build up a confidence of classification that can be applied to certain types of events. For example, if a large number of events comprising a person walking a dog are detected, and in each case the human reviewer has agreed with the AI risk classification, then it may not be necessary to escalate these types of events to a human to review further. Conversely, if the event is one which has not been seen previously or is one which the AI has a low risk classification confidence, it may be necessary to feed this information to a human for review.

Accordingly, the present technology, allow for simultaneous, automated processing of sensor and event information, to extract context from the images, and to analyse a live video feed (such as video feed delivered over a Real-Time Streaming Protocol (RTSP)) for potential threats.

### Examples of the Technology

In one example of the technology a monitoring system comprises one or more sensors, including at least one camera, and a processor configured to processor sensor and/or event information from the one or more sensors. For example, the one or more sensors may include edge-based object detection and may be configured to provide event information to the processor which indicates the type of object or event detected.

In some examples of the technology, the monitoring system may be configured to automatically complete one or more documents. For example, the AI model may prepare regular reports, on the number and nature of events detected, what the decision making was, what recommendations might be to reduce the amount of processing required in the future (such as changing active regions of a video feed).

In other examples, the monitoring system may be configured to automatically generate reports for police or insurance claims.

In some examples a method of monitoring a site is provided, the method comprising the steps of:
A) receiving sensor and/or event information from at least one sensor or positioned to monitor a site:
B) processing the sensor and/or event information to determine whether it meets a monitoring schedule for the site;
C) using an artificial intelligence model to extract additional context information from the sensor and/or event information;
D) determining one or more site rules using natural language processing;
E) comparing the context information, sensor information and/or event information against the site rules to determine whether the site rules have been met or breached;
F) determine a level of risk from the sensor, event and context information; and
G) in the event that the risk exceeds a predetermined threshold, generating an alert via a communications system.

### Disclaimers

Aspects of the present technology relate to the processing of information. It should be appreciated that these systems and methods generally involve the execution of computer readable instructions which may be included in a non-transitory computer readable storage medium, for example memory or other computer program product configured for execution by one or more processors. Accordingly reference to processors or processing should be understood to include the execution of computer readable instructions from a non-transitory computer readable storage medium.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A computer readable storage medium, as used herein, is not to be construed as being transitory signals per se, such as radio waves or other freely propagating electromagnetic waves, electromagnetic waves propagating through a waveguide or other transmission media, or electrical signals transmitted through a wire.

The skilled reader should appreciated that the systems and methods described herein, thereof can alternatively be executed by a device other than a processor and/or embodied in firmware or dedicated hardware in a well-known manner, e.g., it may be implemented by an application specific integrated circuit (ASIC), a programmable logic device (PLD), a field programmable logic device (FPLD), a field programmable gate array (FPGA), discrete logic, etc. For example, any or all of the components can be implemented by software, hardware, and/or firmware. Also, some or all of the instructions represented by the flowcharts may be implemented manually. Further, although the example algorithms are described with reference to the illustrated flowcharts, persons of ordinary skill in the art will readily appreciate that many other methods of implementing the example processor readable instructions may alternatively be used. For example, the order of execution of the blocks may be changed, and/or some of the blocks described may be changed, eliminated, or combined.

1. A monitoring system, comprising:
at least one security sensor configured to receive at least one of sensor and event information about a site being monitored,
a processor communicatively connected to the at least one security sensor, and
a communications system configured to generate alerts,
wherein the processor is configured to:
determine whether alerts should be generated based on a monitoring schedule for the site being monitored,
use an artificial intelligence model to:
extract additional information from the sensor information,
determine one or more rules for the site using natural language processing,
review the sensor, event and context information to determine whether the one or more site rules have been met, and
determine a level of risk from the sensor, event and context information,
wherein, depending on the level of risk, the processor is configured generate an alert via the communications system.

2. The monitoring system of claim 1, wherein the processor is configured to use a large language model to extract additional information from the sensor information.

3. The monitoring system of claim 1, wherein the processor is configured to use a large language model to determine the one or more rules for the site.

4. The monitoring system of claim 1, wherein the processor is configured to use a large language model to review any one or more of the sensor, event and context information to determine whether the one or more site rules have been met.

5. The monitoring system of claim 1, wherein the processor is configured to determine the level of risk using a large language model.

6. The monitoring system of claim 1, wherein the system is configured to communicate the level of risk to a human reviewer for review, prior to generating an alert.

7. The monitoring system of claim 1, wherein the alert comprises at least one of an SMS message, MMS message, an email, push notification, phone call, and an audio/visual indicator.

8. A method of monitoring a site, the method comprising the steps of:
a) receiving at least one of sensor and event information from at least one sensor positioned to monitor a site:
b) processing at least one of the sensor and event information to determine whether it meets a monitoring schedule for the site;
c) using an artificial intelligence model to extract additional context information from at least one of the sensor and event information;
d) determining one or more site rules using natural language processing;
e) comparing at least one of the context information, sensor information and event information against the site rules to determine whether the site rules have been met or breached;
f) determine a level of risk from the sensor, event and context information; and
g) in the event that the risk exceeds a predetermined threshold, generating an alert via a communications system.

9. The method of claim 8, wherein the use of artificial intelligence comprises at least one large language model configured to extract additional information from the sensor information.

10. The method of claim 8, wherein the step of determining one or more site rules involves the use of at least one large language model.

11. The method of claim 8, wherein the step of determining whether the site rules have been met or breached is performed using at least one large language model.

12. The method of claim 8, wherein the step of determining the level of risk is performed using a large language model.

13. The method of claim 8, further comprising the step of communicating the level of risk to a human reviewer for review, prior to step G).

14. The method of claim 13, wherein the alert comprises at least one of an SMS message, MMS message, an email, push notification, phone call, and an audio/visual indicator.
